(19) United States
(12) Patent Application Publication
(10) Pub. No.: US 2004/0120297 A1
(43) Pub. Date: Jun. 24, 2004

(54) Method of and apparatus for providing access control information to a wireless node of a wireless data network

(76) Inventors: James Thomas Edward McDonnell, Malmesbury (GB); Wassim Haddad, Verdun Municipality (CA); John Deryk Waters, Bath (GB); Matthew Murray Williamson, Bristol (GB)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/651,246

(22) Filed: Aug. 29, 2003

(30) Foreign Application Priority Data
Aug. 31, 2002 (GB) 0220259.6

(51) Int. Cl. H04Q 7/24

(52) U.S. Cl. 370/338; 709/217

(57) ABSTRACT

A wireless data network, which covers a first physical area and has a wireless node is increased by generating access control information for the wireless data network. The access control information is communicated to a second wireless network associated with a mains power supply, e.g. a lighting circuit, operative in at least one part of the first physical area located within a secure environment. The access control information is transmitted to the wireless node using the second wireless network. The access control information is changed from time to time (preferably at predetermined intervals). The preceding steps are repeated for each change.

### FIELD OF THE INVENTION

The invention relates to a method of and apparatus for providing access control information, typically access keys, to wireless nodes of wireless data networks.

### BACKGROUND OF THE INVENTION

Wireless data networks, such as wireless local access networks (WLANs), are becoming increasingly popular due to their many advantages over wired networks. WLANs provide all the functionality of wired networks without the physical constraints. Although wireless networks can be more costly to install initially, the installation is often quicker and less disruptive to the work environment than for wired networks. Once installed WLANs provide greater physical mobility within the network area for users, which can in some environments provide much greater productivity. In addition wireless networks can be expanded and altered much more readily than wired networks and thus are more readily adapted to changing requirements than is the case for wired networks.

Wireless networks use radio waves, or in some cases infra red, to communicate information from one point to another without the need for any physical connection. For example a typical WLAN configuration comprises a transmitter/receiver (transceiver) device incorporating an antenna, commonly called an access point, connected to a wired network at a fixed location. The transceiver receives, buffers, and transmits data between the WLAN and the wired network infrastructure. End users access the WLAN through WLAN adapters which are implemented as PC cards in notebook computers, or use ISA (industry standard architecture) or PCI (peripheral component interconnect) adapters in desktop computers, or fully integrated devices within hand held devices such as personal digital assistants (PDAs). The WLAN adapters provide an interface between the network operating system and the radio waves, via an antenna. The nature of the wireless connection is transparent to the network operating system.

FIG. 1, a schematic diagram of a previously developed WLAN, includes WLAN 10 having a number of access points 12 connected to a wired network infrastructure 14 in order to provide appropriate physical coverage, e.g. a whole building 16, or campus. The access points 12 not only provide communication with the wired network infrastructure 14 but also mediate wireless network traffic in the immediate neighbourhood. The area covered by each access point 12 is often referred to as a microcell 18, illustrated in FIG. 1 by broken lined circles. At any time a device, or node, equipped with a WLAN adapter and accessing WLAN 10 is associated with a particular access point 12 and its microcell 18. If the device moves within the coverage of the WLAN, it may move into a different microcell 18 and become associated with a different access point 12.

If the antennae used by the access points 12 are not directional the area covered by a microcell 18 is approximately circular, (although this will be affected by the environment where the antenna is located which can produce reflections etc. which alter the basic coverage). Thus to provide full coverage of an operational area, such as a building 16, or campus, by a WLAN the microcells 18 have overlapping regions that overlap the edge of the area, i.e. building 16, which the WLAN 10 must cover. This provides a security problem, as the coverage of the WLAN 10 extends outside the building 16 potentially including areas 20, shown shaded in FIG. 1, which are likely outside a secure area to which access can reliably be limited and thus provides areas where eavesdroppers can locate a device and seek to gain access to the WLAN 10 and thus to the wired network infrastructure 14 as a whole. For simplicity the areas 20 are referred to as prohibited areas.

The use of security measures based on provision of access control information, such as access keys, passwords, encryption etc., is therefore most important for the security of the WLAN. Furthermore, in order to minimise the possibility of an eavesdropper gaining access to the WLAN by picking up signals over an extended period of time and thereby deciphering the access keys, passwords and encryption codes, it is necessary for at least the access keys used to authorised users in order for them to gain access to the WLAN to be changed regularly. Written or verbal access key distribution is inconvenient, time consuming and not very secure. It would therefore be preferable if access keys could be distributed by an alternative method which is both more convenient and provides greater security.

It is an object of the present invention to provide a new and improved method of and apparatus for mitigating the above identified problem.

### SUMMARY OF THE INVENTION

According to a first aspect of the invention access control information is provided to a wireless node of a wireless data network which operates in a predetermined physical space by:

supplying the access control information to both the wireless data network and a second wireless network associated with a mains power supply, e.g., a lighting circuit, operative in at least part of the predetermined physical space; and

transmitting the access control information to the node using the second wireless network.

The method may comprise the additional step of transporting the node into a location within the at least part of the predetermined physical space where the node can receive the transmissions of the second wireless network.

The method may further include enabling the node to receive transmission of the access control information from the second wireless network while the second wireless network operates in accordance with a different protocol to that employed by the wireless data network.

According to a second aspect of the invention an apparatus for providing access control information to a wireless node of a wireless data network for covering a first physical area, includes a second wireless network associated with a mains power supply, e.g. a lighting circuit, operative in at least part of the first physical area. The second network includes a control unit having with the access control information, and a transmitter for transmission of the access control information to the node.

The second wireless network preferably further includes (1) a data addition element for adding data for transmission of the access control information to the lighting circuit operative within the at least a part of the first physical area covered by the wireless data network, and (2) a data recovery element for recovering the data for transmission of the access control information from the lighting circuit and passes it to the transmitter.

The data recovery element and the transmitter of the second wireless network are conveniently located adjacent to a light emitting unit of the lighting circuit.

The transmitter of the second wireless network preferably comprises a short range transmitter close to which the node must be taken for receipt of the access control information.

Preferably the second wireless network further includes one or more filter elements to prevent the data added to the lighting circuit from passing out of the first physical area on that or any other electrical circuit.

The transmitter of the second wireless network may transmit in accordance with a different protocol to that employed by the wireless data network, in such case the apparatus further includes an appropriate receiver and associated control unit within the node.

The transmitter of the second wireless network may for example operate in the infra red, at radio frequencies and at short range, or in accordance with Bluetooth technology.

The control unit of the second wireless network may be connected to the wireless data network for provision of the access control information thereto.

Alternatively, the control unit of the second wireless network and the wireless data network include synchronised clocks and are from time to time provided with schedules of the access control information and validity periods thereof, such that at any time the second wireless network transmits the current access control information for the wireless data network.

According to a third aspect of the present invention the security of a wireless data network, which covers a first physical area and has a wireless node, is increased by

generating access control information for the wireless data network;

communicating the access control information to a second wireless network associated with a mains power supply, e.g. a lighting circuit, operative in at least one part of the first physical area located within a secure environment;

transmitting the access control information to the wireless node using the second wireless network; and

changing the access control information from time to time (preferably at predetermined intervals) and repeating the preceding steps upon each change.

When the node is able to receive the access control information whilst in the first physical area it is preferable to change the access control information at predetermined intervals of short duration, of less than one hour.

When the node is not able to receive the access control information whilst in the first area, but has to be transported to a different location for receipt of the access control information, it may be convenient to change the access control information at predetermined intervals of relatively long duration, in excess of one hour but less than 48 hours.

### BRIEF DESCRIPTION OF THE DRAWINGS

The present invention will now be described with reference to the accompanying Figures in which:

FIG. 1 is a schematic illustration of a previously developed wireless local area network;

FIG. 2 is a schematic illustration of a WLAN in connection with which the embodiment of the invention is described;

FIG. 3 is a block diagram of one preferred embodiment of the present invention; and

FIG. 4 is a schematic diagram of a data recovery/addition circuit suitable for incorporation into the embodiment of FIG. 3.

### DETAILED DESCRIPTION OF THE DRAWINGS

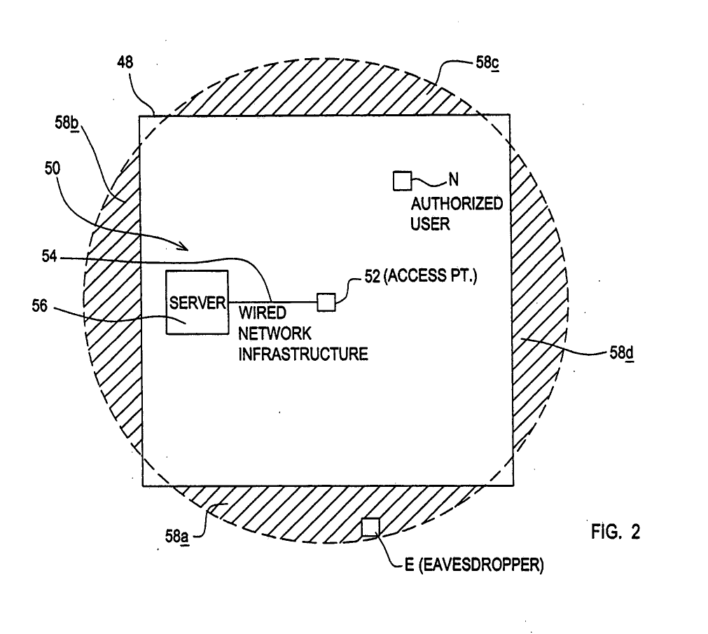

Building 48, FIG. 2, includes a WLAN 50 having a single access point 52 connected to a wired network infrastructure 54 having at least a server 56.

The physical area within which WLAN 50 operates comprises the majority of the area of the building 48, and prohibited areas 58 outside the building 48. Thus an authorised user represented by node N in FIG. 2 can gain access to the WLAN 50. An eavesdropper E who resides in prohibited area 58a can also gain access to WLAN 50. The eavesdropper can, over time, as a result of receiving transmissions of the WLAN 50, decipher the access keys etc.

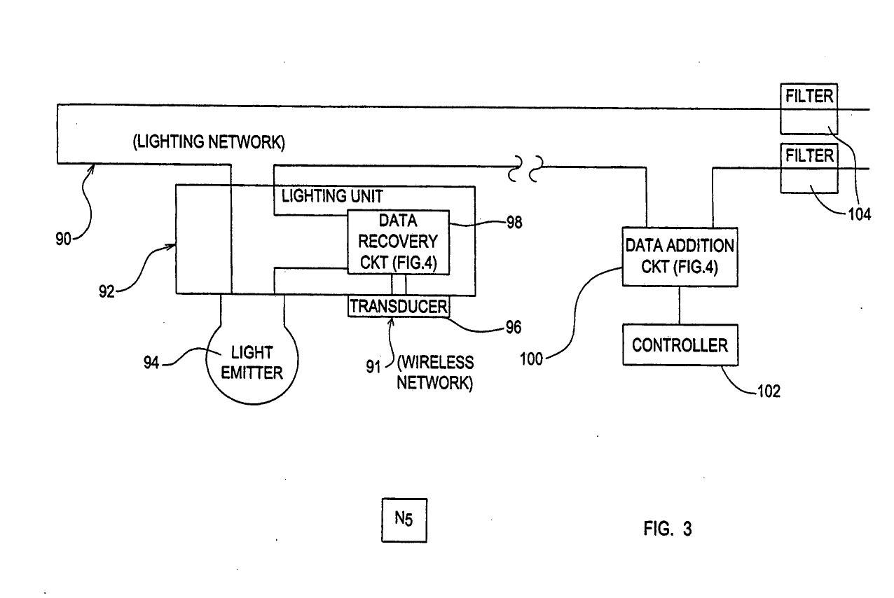

The system of FIG. 3, which is applicable both for fixed and mobile nodes accessing the WLAN 50, utilises a mains network in the form of lighting network 90 within the building 48 and wireless network 91 combined therewith to prevent the eavesdropper from accessing WLAN 50. FIG. 3, as shown, includes a single lighting unit 92, although the lighting network 90 will inevitably include many such units. Each such lighting unit 92 comprises a light bulb, fluorescent tube or other light emitter 94 as used to light the building 48, but also a transducer 96 and a data recovery circuit 98 of the wireless network 91. Thus transducer 96 and light emitter 96 are mounted in the same housing on or in the ceiling of building 48. Also part of the wireless network 91 and added to the otherwise standard lighting network 90 is a data addition circuit 100, a controller 102 and filters 104.

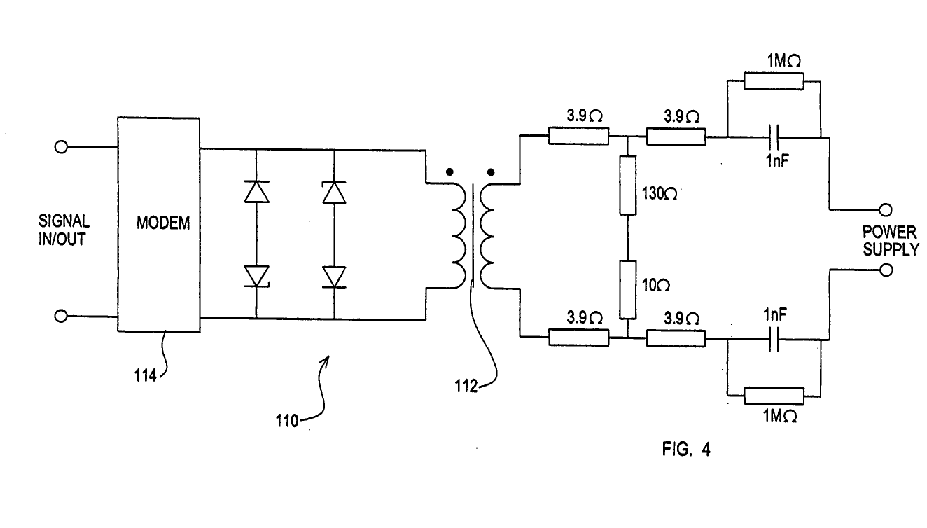

Referring now also to FIG. 4 a circuit 110 suitable for use as either the data recovery circuit 98 or the data addition circuit 100 of FIG. 3 is illustrated. The essential components of the circuit 110 are a transformer 112 and modem 114. The remaining components provide signal conditioning and therefore optimise performance, but are not essential for operation of circuit is 110, and are provided by way of example only.

In the data addition circuit 100 the access key to be transmitted to the nodes N of the WLAN 50 is converted into a form more appropriate for modulation of a 50 or 60 Hz mains power supply by the modem 114 and, for example, is output from the modem 114 as frequency modulation of a carrier having a frequency in the range of 1 to 30 MHz. This modem output signal is inductively coupled onto the mains power supply by transformer 112.

In the data recovery circuit 98 the process is simply reversed. The data signal is recovered from the mains power supply by the transformer 112 and is demodulated by the modem 114 to provide the digital access key signal which is then passed to the transducer 96 for transmission into the building 48 and thus to the nodes N. The filters 104 ensure that the data added to the mains power supply of lighting network 90 does not also pass out of the secure building 48 via the mains electricity supply.

The transducer 96 can be a very low power radio transmitter operating at the same frequencies as the WLAN 50, such that the nodes N do not need additional features to receive the access key. Alternatively the transducer 96 operates in accordance with Bluetooth technology, thus requiring the nodes to be equipped with receivers also in accordance with that technology. In a further alternative the transducer operates in the infra red, which ensures a much lower range, thus requiring the nodes N also to be able to receive infra red transmissions. Such technology is well known and is often employed in such devices as mobile telephones and personal digital assistants (PDAs) to allow them to be linked to other devices such as personal computers (PCs) without the need for cables. In any event the transducer 96 is a very short range device such that the access key can only be received by nodes N substantially below the housing for transducer 96 e.g 1-2 meters, depending upon ceiling height.

The wireless network 91 has the single purpose of transmitting the access keys for the first WLAN 50, thus the controller 102 of the wireless network 91 must be supplied with the access keys for the first WLAN 50 in order to be able to transmit them. This is achieved as follows.

The server 56 of the first WLAN 50 and the control 102 of the wireless network 91 are interconnected in order that access keys generated by the server 56, in known manner, are passed to controller 102 for transmission by the wireless network 91. Alternatively, if it is considered desirable not to provide a physical interconnect between the first WLAN 50 and the wireless network 91 the following protocol can be adopted. Each of server 56 and controller 102 is provided with synchronised clocks and a schedule of access keys and when access keys can be retrieved. These schedules are calculated in the server 56 of the first WLAN 50 and down loaded at predetermined intervals to the controller 102 of the wireless network 91. Alternatively, the schedules are generated elsewhere and downloaded at predetermined intervals to both the server 56 and controller 102. Appropriate intervals for downloading of such schedules may, for example, be 1 week or 1 month. In any event, the result is that at the times when the access key to the first WLAN 50 changes, the wireless network 91 automatically starts to transmit the new access key which can then be picked up by the node or nodes N seeking to access the first WLAN 50.

The combination of the first WLAN 50 and wireless network 91 operates as follows. For a node N to be able to access the first WLAN 50 the node must first be taken into the building 48 that is lit by the lighting network 90 and thus covered by the wireless network 91. While in building 48, node N receives the current access key for the first WLAN 50. The node N can then access the WLAN 50 even when node N leaves the building 48, but remains within the area covered by WLAN 50, until such time as the access key for the first WLAN 50 is changed. When the access key for the first WLAN 50 is changed, the node N is no longer able to access the first WLAN 50, as it will be locked out. Thus the node N will again have to be taken into the building 48 to receive the new access key for the first WLAN 50, and so on.

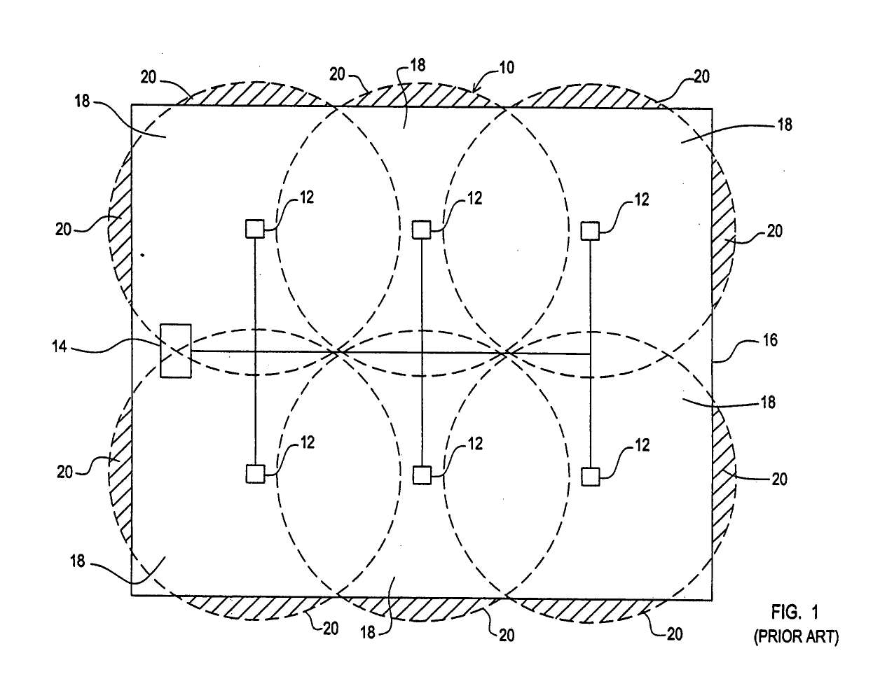

This access arrangement of FIG. 3 has a number of advantages over the arrangement of FIG. 1. First it is almost inevitable that every user is located within the building 48 close to a lighting unit 92, and in direct line of sight with such a lighting unit. Thus it is very unlikely that nodes N would have to be moved in order to receive the access keys for the WLAN 50. Moreover this means that, as nodes will at all times be within range of a lighting unit 92 and able to receive the access key transmission signals, the access key for the WLAN 50 can be changed much more frequently without inconveniencing workers using those nodes. The access key could even be changed every few minutes or even seconds, making it almost impossible for an eavesdropper in the prohibited area to make use of signals received from the WLAN 50.

However, if the building 48 is large it will probably include a number of distinct lighting networks, for example one for each floor. Thus the WLAN 50 might encompass the entire building 48 whilst the wireless network 91 might only be provided on one floor, or another part of the building such as a wing. This could be because only some of those people working in the building 48 require access to the WLAN 50 or because the wireless network 91 is confined to a part of the building 48 which is not adjacent to the prohibited area 58, thus increasing security still further.

In the latter case those people who work outside the area covered by the wireless network 91, but require access to the WLAN 50, would have to carry their personal computer (PC) into that area whenever the access key expired in order to obtain a new one.

It should be understood that the embodiments of the invention are equally applicable to WLANs of different formations, e.g. with more than one access point, covering more than one building, and so on.

1. A method of providing access control information to a wireless node of a wireless data network which operates in a predetermined physical space comprising the steps of:
supplying the access control information and to the wireless data network and a second wireless network associated with a mains power supply operative at in least part of the predetermined physical space;
transmitting the access control information to the node using the second wireless network.

2. A method according to claim 1, wherein the mains power supply comprises a lighting circuit.

3. A method according to claim 1 further comprising transporting the node into a location within the at least part of the predetermined physical space where the node can receive the transmissions of the second wireless network.

4. A method according to claim 1 further including enabling the node to receive transmission of the access control information from the second wireless network while the second wireless network operates in accordance with a different protocol to that employed by the wireless data network.

5. Apparatus for providing access control information to a wireless node of a wireless data network such that the wireless node can gain access to the wireless data network, the wireless data network covering a first physical area, the apparatus comprising a second wireless network associated with a mains power supply operative in at least part of the first physical area, the second wireless network having:
a control unit including the access control information, and
a transmitter for transmission of the access control information to the node.

6. The apparatus according to claim 5 wherein the mains power supply comprises a lighting circuit.

7. Apparatus according to claim 6 wherein the second wireless network further includes a data addition element for adding data for transmission of the access control information to the lighting circuit operative within the at least a part of the first physical area covered by the wireless data network, and a data recovery element for recovering the data for transmission of the access control information from the lighting circuit and passing it to the transmitter.

8. Apparatus according to claim 7 wherein the data recovery element and the transmitter of the second wireless network are located adjacent to a light emitting unit of the lighting circuit.

9. Apparatus according to claim 5 wherein the transmitter of the second wireless network comprises a short range transmitter close to which the node must be taken for receipt of the access control information.

10. Apparatus according to claim 7 wherein the second wireless network further includes one or more filter elements for preventing the data added to the lighting circuit from passing out of the first physical area on that or any other electrical circuit.

11. Apparatus according to claim 5 wherein the transmitter of the second wireless network is arranged for transmitting in accordance with a different protocol to that employed by the wireless data network and the apparatus further includes an appropriate receiver and associated control unit within the node.

12. Apparatus according to claim 11 wherein the transmitter of the second wireless network is arranged to operate in the infra red.

13. Apparatus according to claim 11 wherein the transmitter of the second wireless network is arranged to operate at radio frequencies and only at short range.

14. Apparatus according to claim 11 wherein the transmitter of the second wireless network is arranged to operate in accordance with Bluetooth technology.

15. Apparatus according to claim 5 wherein control unit of the second wireless network is connected to the wireless data network for supplying the access control information thereto.

16. Apparatus according to claim 5 wherein the control unit of the second wireless network and the wireless data network include synchronised clocks and are arranged to receive at predetermined intervals schedules of the access control information and validity periods thereof, for enabling at any time the second wireless network to transmit the current access control information for the wireless data network.

17. A method of increasing the security of a wireless data network, which covers a first physical area, and has a wireless node comprising the steps of:
communicating access control information for the wireless data network to a second wireless network associated with a mains power circuit operative in at least one part of the first physical area located within a secure environment;
transmitting the access control information to the wireless node using the second wireless network;
changing the access control information at predetermined intervals and repeating the preceding steps upon each change.

18. A method according to claim 17, wherein the mains power supply comprises a lighting circuit.

19. A method according to claim 17 further comprising changing the access control information at predetermined intervals of short duration, of less than one hour, when the node is able to receive the access control information whilst in the whole of the first physical area.

20. A method according to claim 18 further comprising changing the access control information at predetermined intervals of relatively long duration, in excess of one hour but less than 48 hours, when the node is not able to receive the access control information whilst in the whole of the first physical area.

21. Apparatus for providing access control keys to a wireless node of a wireless data network such that the wireless node can gain access to the wireless data network, the wireless data network covering a first physical area, the apparatus comprising a second wireless network associated with a mains power circuit operative in at least part of the first physical area, the second wireless network including:
a control unit having the access control information;
a data addition element for adding data for transmission of the access control information to the mains circuit;
a data recovery element for recovering the data for transmission of the access control information from the mains circuit and passing it to the transmitter, and
a transmitter for transmission of the access control information to the node.

22. The apparatus according to claim 21 wherein the mains power supply comprises a lighting circuit.
